(19) United States
(12) Patent Application Publication
(10) Pub. No.: US 2010/0007135 A1
(43) Pub. Date: Jan. 14, 2010

(54) Fiberglass Pipe-shaped Insulator and Method of Manufacturing the Same

(76) Inventor: Pil-Se Lee, Andong-si (KR)

Correspondence Address: PARK LAW FIRM, 3255 WILSHIRE BLVD, SUITE 1110, LOS ANGELES, CA, 90010, US

(21) Appl. No.: 12/170,714

(22) Filed: Jul. 10, 2008

(51) Int. Cl. F16L 59/14; F16L 9/22

(52) U.S. Cl. 285/53; 138/167

(57) ABSTRACT

A fiberglass pipe-shaped insulator and a method of manufacturing the same are disclosed. The high-density fiberglass pipe-shaped insulator is manufactured by preparing a fiberglass needle mat formed at opposite sides thereof with cutting faces at unaligned positions, at least one surface of the fiberglass needle mat being coated with a binder prepared by mixing and agitating organic and inorganic substances, a fire retardant and water and selectively mixing and agitating a water repellent with the resultant mixture; press-forming the fiberglass needle mat using a press roller in a state wherein the fiberglass needle mat is wound on a forming roller; drying a press-formed fiberglass pipe-shaped insulator prior to separating the insulator from the forming roller; performing center cutting on the fiberglass pipe-shaped insulator; attaching an aluminum glass cross tape throughout an outer circumferential surface of the pipe-shaped insulator; and performing side cutting on the fiberglass pipe-shaped insulator.

### BACKGROUND OF THE INVENTION

1. Field of the Invention

The present invention relates to a fiberglass pipe-shaped insulator for use in piping insulation of power plants, petrochemical plants, various ships, etc., and a method of manufacturing the same.

2. Description of the Related Art

In general, all heating and cooling piping, which is used to convey fluid therethrough, have been proposed to be wrapped, at an outer circumferential surface thereof, with a heat-insulating material, for the reasons of, for example, preventing change in physical properties of the fluid or reducing consumption of energy. In particular, since piping, used in power plants, petrochemical plants, various ships, etc., may be subjected to extremely high temperatures generated from fluid being conveyed through the piping, a heat-insulating material for use with the piping must be fabricated via a forming process using a high fusion point material, in order to eliminate the risk of fire due to the heat-insulating material while achieving satisfactory heat-insulating effects.

Conventionally, perlite and calcium silicate heat-insulating materials have been used as fireproof heat-insulating materials. However, these heat-insulating materials must be essentially formed into blocks using molds in consideration of characteristics of the materials, and the resulting blocks have poor constructability due to heavy weight and low strength thereof and are easily broken even by slight external shock during construction and during use. Consequently, the above mentioned conventional heat-insulating materials have disadvantages such as a shorter lifespan than piping and additional exchange costs, etc.

For this reason, there has been recently developed and used a pipe-shaped insulator, which is fabricated by a method comprising: preparing a mat made of rock wool, glass fibers, or the like, a surface of the mat being coated with a binder for attachment of the mat; and performing forming and joining processes with the aid of the binder in a state wherein the resulting mat is wound on a forming roller. With relation to the forming process of the pipe-shaped insulator in the above-described method, however, the pipe-shaped insulator must be fabricated to a significantly thick thickness in order to achieve desired heat-insulation efficiency because it is difficult to provide the pipe-shaped insulator with a high-density due to the inherent bulk of glass fibers. Therefore, transportation and installation of the resulting heat-insulating material are difficult due to a large volume thereof and require an extensive construction space, resulting in deterioration in space utility. Moreover, the above-described pipe-shaped insulator is easily deformed even by slight external shock, resulting in difficulty in construction and poor construction quality.

In addition, rock wool or glass fibers, used in the forming process of the conventional pipe-shaped insulator, have a high fusion point, whereas most binders used for attachment of the mat have low fusion points. Therefore, in particular, when used in piping insulation of power plants, petrochemical plants, etc. in which temperatures of approximately 60 degrees centigrade are encountered, an adhesive force of the mat deteriorate as the binder undergoes carbonization at high temperatures, resulting in re-construction costs. As additional disadvantages of the above-described pipe-shaped insulator under high-temperatures, water condensates may be generated due to a temperature difference with the outside air during use, and the glass fibers of the pipe-shaped insulator are highly absorbent and cannot exhibit efficient water repellency upon exposure of moisture levels under snowy or rainy conditions. These disadvantages results in not only deterioration in heat-insulating performance, but also increased pipe weight, causing serious negative effects in the safety of structures incorporating the pipe-shaped insulator.

Moreover, during the forming process of the pipe-shaped insulator using the forming roller, formation of a lengthy pipe is impossible and connection of plural pipes is required to achieve a desired pipe length. However, since it is difficult to provide additional coupling means due to characteristics of materials and fabrication methods employed in the pipe-shaped insulator, actual construction is conventionally performed in such a manner that connection of the pipe-shaped insulators is simply maintained by tight contact of plural pipe-shaped insulators. With this construction method, however, heat loss due to gaps between the pipe-shaped insulators causes many disadvantages including deterioration in heat-insulation performance, financial loss due to energy consumption, and the like.

### SUMMARY OF THE INVENTION

Therefore, the present invention has been made in view of the above problems, and it is an object of the present invention to provide a fiberglass pipe-shaped insulator and a method of manufacturing the same, wherein excellent heat insulation efficiency and high strength of the fiberglass pipe-shaped insulator can be accomplished via an operation for increasing the density of glass fibers and via the use of a strength reinforcing binder, wherein the binder used for interlayer attachment of a fiberglass needle mat can maintain a superior adhesive force even under high-temperature conditions without a risk of carbonization, assuring an extended lifespan of the fiberglass pipe-shaped insulator and if necessary, a water repellent is added to the binder, thereby eliminating risks of deterioration in heat insulation efficiency and deterioration in the strength of structures incorporating the fiberglass pipe-shaped insulator due to moisture, and wherein a female-to-male engagement between pipe-shaped insulators can be accomplished upon construction, preventing heat loss via connecting regions between the pipe-shaped insulators.

In accordance with the present invention, the above and other objects can be accomplished by the provision of a fiberglass pipe-shaped insulator and a method of manufacturing the same, the manufacturing method comprising: preparing a fiberglass needle mat via needle punching of glass fibers, the fiberglass needle mat being formed at opposite sides thereof with cutting faces at unaligned positions, a surface of the fiberglass needle mat being coated with a fire retardant binder, prepared by mixing and agitating an adhesive organic substance, a strength reinforcing inorganic substance, a fire retardant and water and selectively mixing and agitating a water repellent with the resultant mixture; press-forming the fiberglass needle mat using a press roller while rotating the fiberglass needle mat in a state wherein the fiberglass needle mat is wound on a forming roller; drying a resulting press-formed fiberglass pipe-shaped insulator prior to separating the fiberglass pipe-shaped insulator from the forming roller; performing center cutting on the fiberglass pipe-shaped insulator; attaching an aluminum glass cross tape throughout an outer circumferential surface of the centrally cut fiberglass pipe-shaped insulator; and performing side cutting on opposite ends of the fiberglass pipe-shaped insulator, to form a coupling recess and a coupling protrusion at both the ends of the fiberglass pipe-shaped insulator, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual view illustrating a needle punching operation in accordance with the present invention;

FIG. 2 is a perspective view illustrating a fiberglass needle mat prepared via the needle punching operation of FIG. 1;

FIG. 3 is a conceptual view illustrating a press-forming operation in accordance with the present invention;

FIG. 4 is a perspective view illustrating a fiberglass pipe-shaped insulator in accordance with a first embodiment of the present invention, which is separated from a forming roller after being dried;

FIG. 5 is a perspective view illustrating center cutting of the fiberglass pipe-shaped insulator in accordance with the first embodiment of the present invention;

FIG. 6 is a perspective view illustrating an operation of attaching an aluminum glass cross tape to the fiberglass pipe-shaped insulator in accordance with the first embodiment of the present invention;

FIG. 7 is a perspective view illustrating side cutting of the fiberglass pipe-shaped insulator in accordance with the first embodiment of the present invention;

FIG. 8 is a perspective view illustrating the fiberglass pipe-shaped insulator in accordance with the present invention, which is cut in half;

FIG. 9 is a perspective view illustrating a fiberglass needle mat in accordance with a second embodiment of the present invention;

FIG. 10 is a perspective view illustrating center cutting of a fiberglass pipe-shaped insulator in accordance with the second embodiment of the present invention;

FIG. 11 is a perspective view illustrating an operation of attaching an aluminum glass cross tape to the fiberglass pipe-shaped insulator in accordance with the second embodiment of the present invention;

FIG. 12 is a perspective view illustrating side cutting of the fiberglass pipe-shaped insulator in accordance with the second embodiment of the present invention; and

FIG. 13 is a partial perspective view illustrating coupling between the fiberglass pipe-shaped insulators in accordance with the second embodiment of the present invention.

### DETAILED DESCRIPTION OF THE PREFERRED EMBODIMENTS

Hereinafter, preferred embodiments of the present invention will be described with reference to the accompanying drawings. It should be noted that the scope of the present invention is not limited to results of the following embodiments and the accompanying claims, and the present invention can be embodied into other configurations.

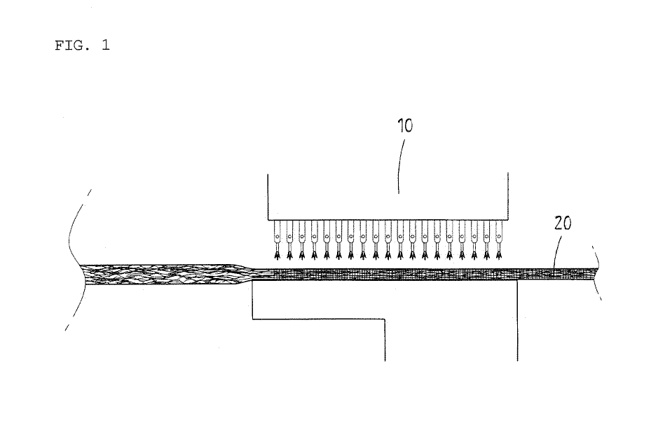

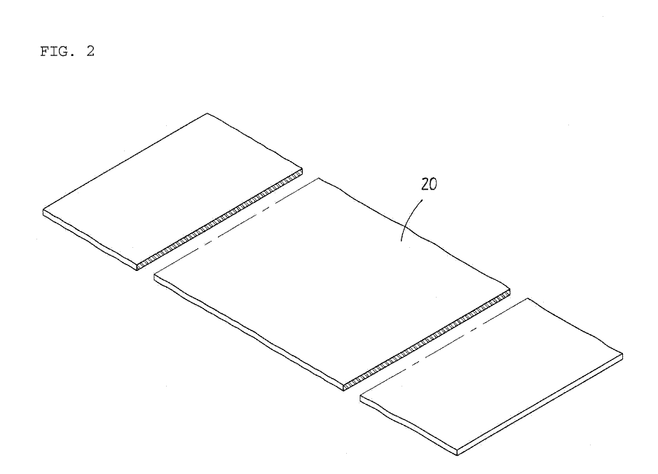

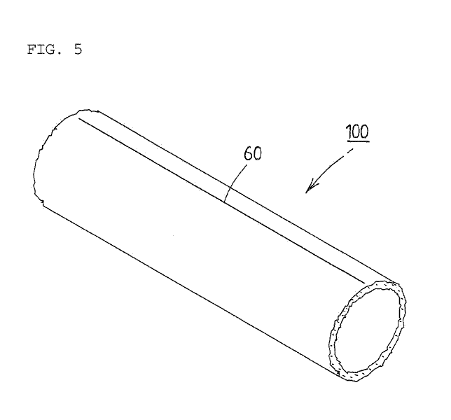

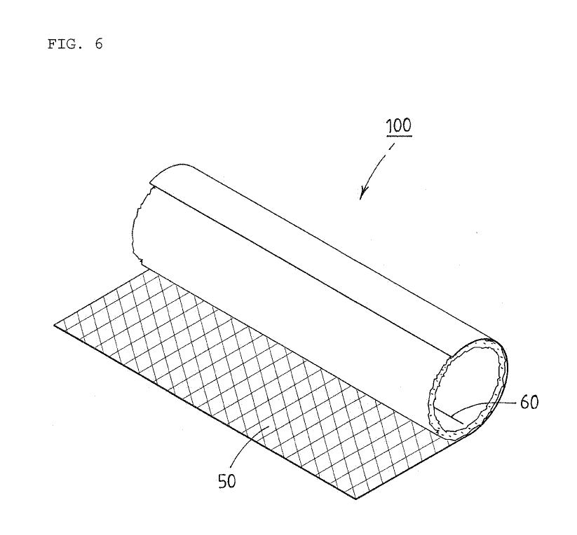

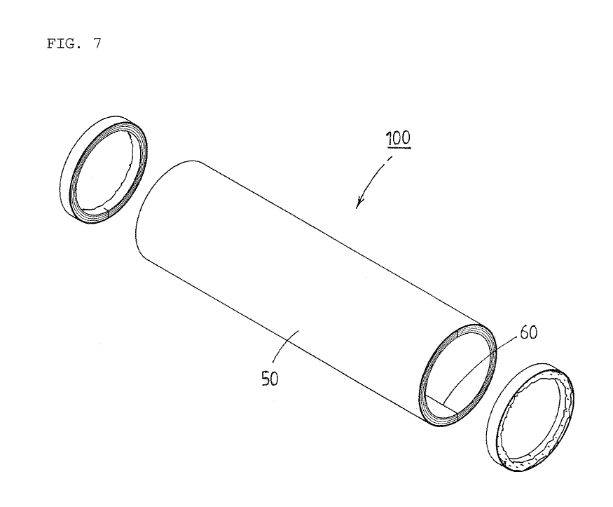

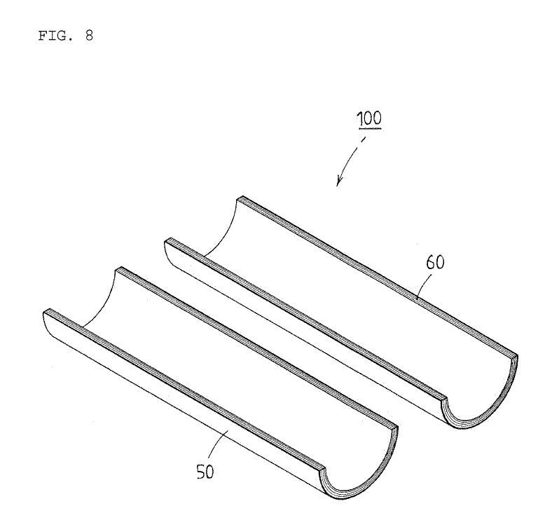

FIGS. 1 to 8 illustrate an embodiment of the present invention. Specifically, FIG. 1 illustrates a needle punching operation for preparing a fiberglass needle mat in accordance with the present invention, and FIG. 2 illustrates the fiberglass needle mat prepared via the needle punching operation of FIG. 1.

In the present invention, first, a fiberglass needle mat 20 is prepared via a needle punching operation using a needle punching machine 10. The needle punching machine 10 uses elongated glass fibers that are formed into relatively thin and long fibers. The needle punching operation reinforces binding force between the glass fibers, enabling preparation of the high-density fiberglass needle mat 20.

In the above-described preparation of the fiberglass needle mat 20, using the elongated glass fibers serves to improve operation efficiency, and the elongated glass fibers can be cut to a desired length. Of course, it is noted that, if necessary, a single pipe-shaped insulator 100, which is made of glass fibers, can be formed to a desired short length.

The needle punching machine 10 for use in the above-described needle punching operation may be configured into a plate type in which a plurality of needles are densely arranged at a lower surface of a punching plate as shown in FIG. 1. Alternatively, the needle punching machine 10 may be configured into a roller type in which a plurality of needles is radially arranged about an outer circumferential surface of a roller. Of course, any other types of needle punching machines can be used so long as they can perform a needle punching operation on glass fibers.

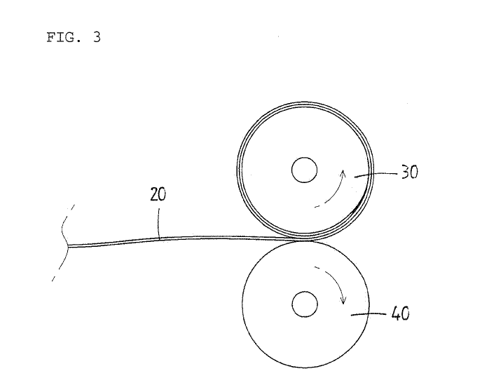

FIG. 3 is a conceptual view illustrating a press-forming operation in accordance with the present invention, which is performed in a state wherein the fiberglass needle mat is wound on a forming roller. The fiberglass needle mat 20 is coated, at one surface or both surfaces thereof, with a binder, which provides the fiberglass needle mat 20, prepared via the needle punching operation of glass fibers, with fire retardancy and, as occasion demands, selectively provides the fiberglass needle mat 20 with water repellency. An appropriate amount of the coated fiberglass needle mat 20 is wound on a forming roller 30 and is subjected to press-forming by use of a press roller 40.

The forming roller 30 has the same diameter as a desired inner diameter of the fiberglass pipe-shaped insulator 100. The inner diameter of the fiberglass pipe-shaped insulator 100 is determined by an outer diameter of the forming roller 30.

The binder also serves as an interlayer adhesive for the fiberglass needle mat 20. Such a binder is obtained by mixing and agitating bentonite as an inorganic substance, Carboxyl Methyl Cellulose (CMC) as an organic substrate, magnesium hydroxide (Mg(OH)₂) as a fire retardant and water, and serves as a fire retardant binder. If necessary, an appropriate amount of fluorine-based water repellent can be added to the binder, to provide the binder with water repellency. The bentonite as an inorganic substrate serves to reinforce the binder, the CMC as an organic substrate provides an adhesive force, the magnesium hydroxide as a fire retardant provides fire retardancy, and the water repellent provides permeability. Of course, it will be appreciated that other materials of similar function can replace the above mentioned materials, and certain similar functional materials can be added to achieve further enhancement.

For example, instead of bentonite, another inorganic substrate, such as silica-sol, water-glass, or the like, may be added. Also, another organic substance, such as gelatin, starch, urethane resin, or the like, may be selectively added to the CMC.

As could be confirmed from results of repeated experiments to obtain an optimum binder, a specific material agitating order and specific input amounts of respective components is preferred, in order to achieve perfect agitation and optimum performance of the components.

More specifically, in consideration of the fact that bentonite is easily distributed at a high temperature, 2 to 6% by volume bentonite powder is first mixed with 94 to 98% by volume water that was previously heated to about 80 degrees centigrade, and then, the resulting bentonite mixture is agitated while being heated to 100 degrees centigrade, to thereby obtain a primary agitated product in which bentonite is sufficiently distributed. Thereafter, 2 to 7% by volume magnesium hydroxide as a fire retardant is mixed and agitated with 93 to 98% by volume of the primary agitated product, to obtain a secondary agitated product, and 7 to 16% by volume CMC as an organic substance is mixed and agitated with 84 to 93% by volume of the secondary agitated product, so as to complete the binder. If necessary, 0.2 to 1% by volume of a fluorine-based water repellent is mixed and agitated with 99 to 99.8% by volume of the binder, to impart the binder with water repellency.

With relation to coating the fiberglass needle mat 20 with the binder, an appropriate amount of the binder, required to achieve interlayer attachment of the fiberglass needle mat 20, is generally coated over one surface or both surfaces of the fiberglass needle mat 20. However, when it is desired to reinforce the strength of the fiberglass needle mat 20 by reinforcing binding force between the glass fibers, or to provide the fiberglass needle mat 20 with water repellency, it is preferred that an extra amount of binder, exceeding the amount of binder required to achieve the interlayer attachment of the fiberglass needle mat 20 be coated, whereby a part of the binder can deeply permeate the fiberglass needle mat 20.

Of course, dehydrating excess binder is preferable. Upon implementation of the dehydration, in particular, the binder can more deeply and uniformly permeate the fiberglass needle mat 20.

In the present invention, the fiberglass needle mat 20 is formed to a long length, and is wound on the forming roller 30 after being cut to a desired length. As the thickness of the fiberglass needle mat 20 increases, it is preferred that the fiberglass needle mat 20 be cut to have a more steep cutting face, or be cut by a tensile force. This allows the fiberglass needle mat 20 to be smoothly wound on the forming roller 30 without causing protrusions.

With relation to winding the fiberglass needle mat 20 on the forming roller 30, furthermore, it is preferred that the fiberglass needle mat 20 be wound on the forming roller 30 under tension as the fiberglass needle mat 20 is pressed by the press-roller 40 from the initial stage of winding. After winding, the forming roller 30 and the press roller 40 are rotated under the influence of a press force of the press roller 40, such that the fiberglass needle mat 20 can be entirely press-formed. Accordingly, in the case where a great amount of binder is coated to achieve reinforced binding force between glass fibers and water repellency, etc., the binder can deeply permeate the fiberglass needle mat 20 as the fiberglass needle mat 20 is press-formed by the press roller 40. Moreover, by increasing a rotating speed of the forming roller 30 and the press roller 40, an increased centrifugal force causes the binder to more deeply permeate the fiberglass needle mat 20 while achieving efficient dehydration of excess binder.

Preferably, the fiberglass pipe-shaped insulator 100, press-formed using the forming roller 30 and the press roller 40, is sufficiently dried prior to being separated from the forming roller 30. This prevents a change in an inner diameter of the fiberglass pipe-shaped insulator 100 even if the glass fibers generate a restitution force, achieving a desired inner diameter of the fiberglass pipe-shaped insulator 100.

The fiberglass pipe-shaped insulator 100 according to the present invention can be formed to various diameters from a minimum value of 0.5 inches to a maximum value of 42 inches. When a general hot-air drier is used to dry the fiberglass pipe-shaped insulator 100, drying conditions must be changed according to diameters or thicknesses of products. Also, when a recently widely used microwave drier is used, the fiberglass pipe-shaped insulator 100 can be dried to have zero moisture content within a short time regardless of desired sizes of the fiberglass pipe-shaped insulator 100. Therefore, it will be appreciated that all kinds of drying operations are applicable to the present invention so long as the drying operations can be performed under temperature conditions below combustion temperatures of the glass fibers and fire retardant binder, and moreover, even natural drying, if time permits, of the fiberglass pipe-shaped insulator 100 is applicable to the present invention.

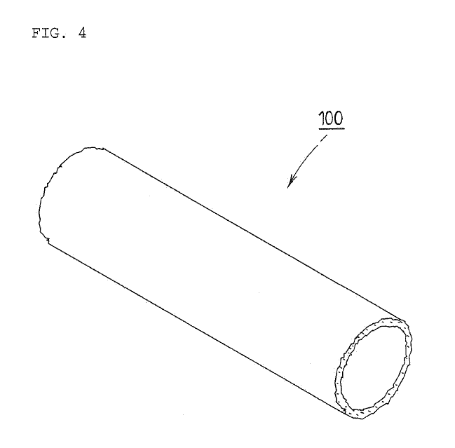

FIGS. 4 to 8 illustrate sequential center cutting, attachment of an aluminum glass cross tape and side cutting of the dried fiberglass pipe-shaped insulator, and a state wherein the fiberglass pipe-shaped insulator in accordance with the present invention is cut in half. After being dried, the fiberglass pipe-shaped insulator 100 is separated from the forming roller 30 and then, is subjected to center cutting in a longitudinal direction of the fiberglass pipe-shaped insulator 100, generating center cutting lines 60. Thereafter, an aluminum glass cross tape 50 is attached throughout an outer circumferential surface of the fiberglass pipe-shaped insulator 100. Finally, the fiberglass pipe-shaped insulator 100 is subjected to side cutting, whereby a desired length of the fiberglass pipe-shaped insulator 100 is completed. As one side or both sides of the aluminum glass cross tape 50 are removed by cutting along the center cutting lines 60, the fiberglass pipe-shaped insulator 100 can be coupled to previously installed piping.

With relation to attaching the aluminum glass cross tape 50 to the outer circumferential surface of the centrally cut fiberglass pipe-shaped insulator 100, it can be appreciated that it is difficult to attach the aluminum glass cross tape 50 if the fiberglass pipe-shaped insulator 100 is completely cut in half. Therefore, it is preferred that both end regions of the fiberglass pipe-shaped insulator 100 be not cut to maintain a cylindrical shape and then, the aluminum glass cross tape 50 be attached to the cylindrical fiberglass pipe-shaped insulator 100. Since both the end regions of the fiberglass pipe-shaped insulator 100, which are not cut, can be removed by side cutting, the fiberglass pipe-shaped insulator 100 can be completely cut in half.

The aluminum glass cross tape 50 serves to improve a product value and also, serves to maintain a smooth surface, thereby preventing the glass fibers from touching the operator′ body, achieving easy handling and construction of the fiberglass pipe-shaped insulator 100. In particular, when a rubber sheet is used as a finishing material prior to application to piping, the aluminum glass cross tape 50 can reinforce an adhesive force of the rubber sheet. Since the aluminum glass cross tape 50 is not removed upon construction, it is preferred that a binder for use in the attachment of the aluminum glass cross tape 50 also be selected from among fire retardant binders.

In addition, even if the fiberglass pipe-shaped insulator 100 is completely cut in half by center cutting and side cutting, the aluminum glass cross tape 50 can maintain a cylindrical shape before being cut. Therefore, when the fiberglass pipe-shaped insulator 100 has a small diameter and is light, the fiberglass pipe-shaped insulator 100 can be transported to a construction site while maintaining a cylindrical shape because the aluminum glass cross tape 50 is not cut, and can then be cut at the construction site. Also, upon construction, by cutting only one side of the aluminum glass cross tape 50 and spreading the aluminum glass cross tape 50, the fiberglass pipe-shaped insulator 100 can be coupled to piping. On the other hand, when the fiberglass pipe-shaped insulator 100 has a large diameter and is heavy, it is preferred that the aluminum glass cross tape 50 be cut in half along the center cutting lines 60 of the fiberglass pipe-shaped insulator 100, whereby the separated left and right halves are transported and assembled individually.

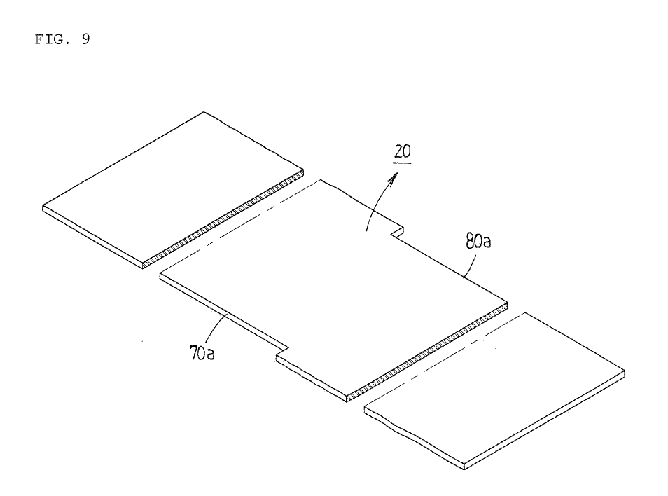

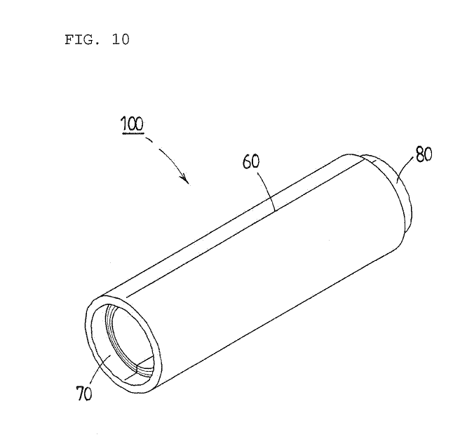

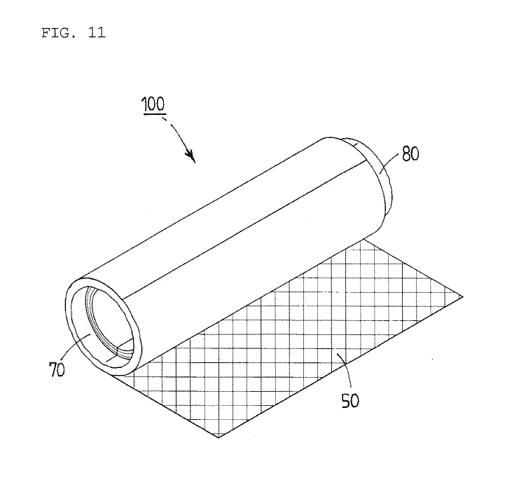

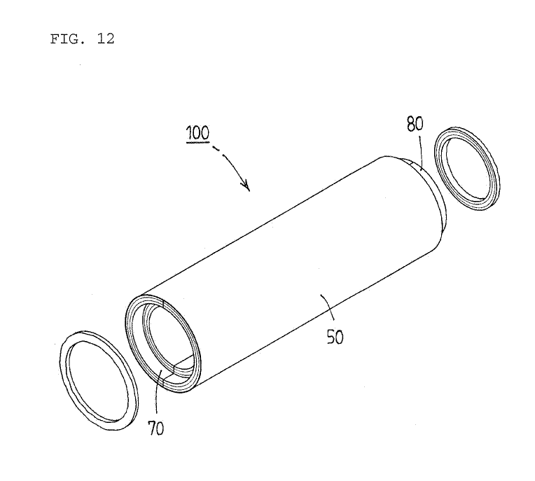

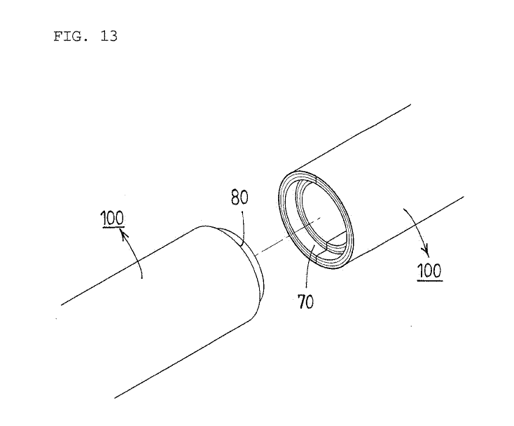

FIGS. 9 to 13 illustrate a second embodiment of the present invention. The present embodiment illustrates that, during a forming process using a fiberglass needle mat 20, the fiberglass pipe-shaped insulator 100 is provided at opposite sides thereof with a coupling recess 70 and a coupling protrusion 80 for a female-to-male engagement between plural fiberglass pipe-shaped insulators 100.

FIG. 9 illustrates a fiberglass needle mat, which is prepared by needle punching and is cut to a desired length of a single fiberglass pipe-shaped insulator. Also, as compared to FIG. 2, in the fiberglass needle mat shown in FIG. 9, partial opposite side regions of the fiberglass needle mat 20 are removed by cutting, producing cutting faces 70a and 80a at unaligned positions.

More specifically, any one side of the fiberglass needle mat 20 is partially removed, by cutting, starting from a corner to a position slightly passing a center point of the fiberglass needle mat 20. In this case, if possible, the cutting of the fiberglass needle mat 20 is performed linearly. Similarly, the other side of the fiberglass needle mat 20 is partially removed, by cutting, starting from a diagonally opposite corner to a position slightly passing the center point of the fiberglass needle mat 20, and the cutting is performed linearly. Thereby, cutting faces 70a and 80a, which are formed at unaligned positions, but partially overlap each other, can be obtained.

Here, partially overlapping the cutting faces 70a and 80a serves to provide a slight gap upon female-to-male engagement via the coupling recess 70 and the coupling protrusion 80, enabling easy coupling between the fiberglass pipe-shaped insulators 100.

Cutting widths of the cutting faces 70a and 80a determine a resulting female-to-male coupling width, and can be set to desired values. However, it is preferred that the cutting widths of the cutting faces 70a and 80a be equal to each other and, when the forming roller 30 and the press roller 40 have cylindrical shapes, the cutting widths be reduced if possible, to allow even non-cut regions of the fiberglass needle mat 20 to be pressed during the press-forming process.

After forming the unaligned cutting faces 70a and 80a at opposite sides of the fiberglass needle mat 20, the fiberglass needle mat 20 is sequentially subjected to press-forming and drying as described above. Specifically, the fiberglass needle mat 20 is press-formed by the press roller 40 while being rotated in a state wherein it is wound on the forming roller 30. Then, the resulting press-formed fiberglass pipe-shaped insulator 100 is dried prior to being separated from the forming roller 30, achieving the fiberglass pipe-shaped insulator 100 having the coupling recess 70 and the coupling protrusion 80 at opposite ends thereof.

With relation to press-forming using the fiberglass needle mat 20 having the cutting faces 70a and 80a at opposite sides thereof, if the fiberglass needle mat 20 is wound on the forming roller 30 starting from any one of upper and lower ends thereof without specifying a given direction, any one of the cutting faces extending from the starting point, for example, the cutting face 70a is wound first. Then, after the cutting face 70a is completely wound via a continuous winding operation, a non-cut region extending from the cutting face 70a is wound, thereby yielding the coupling recess 70 inwardly recessed from one end of the fiberglass pipe-shaped insulator 100. Also, in the case of the other cutting face 80a formed starting from a location in front of the center point of the opposite side of the fiberglass needle mat 20 to a diagonally opposite end of the opposite side, a non-cut region extending from the cutting face 80 is wound first and protrudes from the cutting face 80a, thereby naturally forming the coupling protrusion 80.

Since both the cutting faces 70a and 80a partially overlap each other, an inner diameter of the coupling recess 70 is slightly larger than an outer diameter of the coupling protrusion 80 in a state wherein the fiberglass needle mat 20 is completely wound. This assures easy female-to-male engagement between the fiberglass pipe-shaped insulators 100.

With relation to using the fiberglass needle mat 20 having the cutting faces 70a and 80a formed at opposite sides thereof, according to shapes of the coupling recess 70 and the coupling protrusion 80 obtained when the fiberglass needle mat 20 is wound on the forming roller 30, one side of the forming roller 30 may be provided with an auxiliary forming portion thicker than the remaining portion thereof, and an opposite side of the press roller 40 may be provided with an auxiliary press portion thicker than the remaining portion thereof. In this case, a strong press force can be applied to the non-cut region of the coupling recess 70 and the coupling protrusion 80. However, with the use of the thicker auxiliary forming portion and the thicker auxiliary press portion, the press force of the press roller 40 cannot be applied while the fiberglass needle mat 20 is wound on the forming roller 30. For this reason, it is preferred that the fiberglass needle mat 20 having the cutting faces 70a and 80a be press-formed using the forming roller 30 and the press roller 40 of the general cylindrical shape.

It is noted that, upon press-forming using the forming roller 30 and the press roller 40 of the above-described general shape, reducing the widths of the coupling recess 70 and the coupling protrusion 80 is preferable. With this configuration, when the press roller 40 applies a press force to the fiberglass needle mat 20 which has a reinforced supporting force by a high density thereof obtained by needle punching, the fiberglass needle mat 20 exhibits an inherent supporting force, allowing the press force to be transmitted even to the non-cut region of the coupling recess 70 and the coupling protrusion 80. As a result, the press-forming using an appropriate press force can be accomplished.

After completing the press forming using the forming roller 30 and the press roller 40, the resulting press-formed fiberglass pipe-shaped insulator 100 is sufficiently dried prior to being separated from the forming roller 30, and then, is sequentially subjected to center cutting, attachment of the aluminum glass cross tape 50 and side cutting, thereby yielding a finished product. In this case, the aluminum glass cross 50 is attached throughout the fiberglass pipe-shaped insulator 100 except for the coupling protrusion 80. Also, with the linear cutting faces 70a and 80a, the coupling recess 70 and the coupling protrusion 80 define planes naturally perpendicular to a circumferential wall of the fiberglass pipe-shaped insulator 100. Accordingly, a desired completed shape of the fiberglass pipe-shaped insulator 100 can be accomplished by side cutting for cutting both ends of the pipe 100.

In the present invention, although the glass fibers constituting the fiberglass needle mat 20 are bulky similar to general fibers, the fiberglass needle mat 20, having passed through a needle punching machine, can achieve a high density and the density of the fiberglass needle mat 20 can be further enhanced while the fiberglass needle mat 20 is press-formed by the press roller 40 in a state wherein it is wound on the forming roller 30. As a result, the fiberglass needle mat 20 can achieve high heat-insulation efficiency even with a thin thickness.

Further, in the present invention, the binder used for the interlayer attachment of the fiberglass needle mat 20 contains CMC as an organic substance to achieve a sufficient adhesive force and bentonite as an inorganic substance to reinforce the adhesive intensity of the binder. Accordingly, by virtue of the strength reinforcement effects using the binder as well as the high density of the fiberglass needle mat 20, the resulting fiberglass pipe-shaped insulator 100 has no risk of deformation even if large shock is applied during handling or construction. Furthermore, magnesium hydroxide as a fire retardant additive of the binder can dilute the density of certain components of the inorganic and organic substances that may be combustible in air, and also, can remarkably reduce a discharge amount of smoke upon burning, achieving a sufficient adhesive force even under high temperature conditions and substantially eliminating the generation of smoke.

Furthermore, in the present invention, by sufficiently drying the press-formed fiberglass pipe-shaped insulator 100 prior to separating it from the forming roller 30, there is no risk of change in the inner diameter of the fiberglass pipe-shaped insulator 100 during drying, thereby preventing generation of defects. Also, this eliminates the risk of an unnecessary gap between the fiberglass pipe-shaped insulator 100 and piping upon construction, preventing deterioration in heat-insulation efficiency.

Moreover, in the present invention, by forming the unaligned cutting faces 70a and 80a at opposite sides of the fiberglass needle mat 20, when the fiberglass needle mat 20 is wound on the forming roller 30, the fiberglass pipe-shaped insulator 100 is provided at opposite ends thereof with the coupling recess 70 and the coupling protrusion 80. Accordingly, upon construction, a female-to-male engagement using the coupling recess 70 and the coupling protrusion 80 can be accomplished between the fiberglass pipe-shaped insulators 100. With such a stronger and tighter coupling as compared to a simple contact between the fiberglass pipe-shaped insulators 100, heat loss at connecting regions of the fiberglass pipe-shaped insulators 100 can be minimized.

As apparent from the above description, the present invention provides a fiberglass pipe-shaped insulator and a method of manufacturing the same, which have the following effects.

Firstly, according to the present invention, a fiberglass needle mat, prepared by needle punching of glass fibers, is press-formed using a press roller in a state wherein it is wound on a forming roller. With this press-forming process, the resulting fiberglass pipe-shaped insulator can achieve excellent heat insulation efficiency even with a thin thickness by virtue of an increased density thereof, thereby enabling easy transportation and construction via a reduced volume thereof, and improving space utilization efficiency because it does not occupy a large space upon construction.

Secondly, the fiberglass pipe-shaped insulator according to the present invention can achieve an enhanced strength in proportion to the increased density. Further, with strength reinforcement effects obtained from bentonite as an inorganic substance constituting a binder, the fiberglass pipe-shaped insulator has no risk of deformation even if large shock is applied there during handling, construction, or various tests including a water leakage test. This has the effects of preventing deterioration in heat insulation efficiency and eliminating a difficulty in construction and the risk of improper construction.

Thirdly, according to the present invention, since the press-formed fiberglass pipe-shaped insulator is subjected to drying in a state wherein it is wound on the forming roller, the fiberglass pipe-shaped insulator has no risk of a change in an inner diameter thereof even under the influence of a restitution force of glass fibers during drying, and can eliminate deterioration in heat insulation efficiency due to an unnecessary gap between the fiberglass pipe-shaped insulator and piping during construction.

Fourthly, the binder for interlayer attachment of the fiberglass needle mat contains magnesium hydroxide and thus, is fire retardant. With the use of the fire retardant binder, the fiberglass pipe-shaped insulator can achieve an extended lifespan without a risk of carbonization of the binder even under high temperature conditions. If necessary, a water repellent is further added to the binder, to enable rapid dehydration of the fiberglass pipe-shaped insulator upon permeation of moisture, thereby eliminating deterioration in heat insulation efficiency and the strength of structures incorporating the fiberglass pipe-shaped insulator due to moisture.

Fifthly, according to the present invention, partial opposite side regions of the fiber-glass needle mat are removed by cutting at unaligned positions to form cutting faces prior to winding the fiber-glass needle mat on the forming roller. Thereby, when the fiber-glass needle mat is press-formed in a state wherein it is wound on the forming roller, the press-formed fiber-glass pipe-shaped insulator is formed with a coupling recess and a coupling protrusion resulting from the cutting faces. The coupling recess and the coupling protrusion enable a strong female-to-male engagement between the plural fiber-glass pipe-shaped insulators upon construction, preventing energy loss caused from gaps between the fiber-glass pipe-shaped insulators.

Sixthly, since an aluminum glass cross tape is attached throughout an outer circumferential surface of the fiber-glass pipe-shaped insulator, there is no risk of glass fibers coming into contact with the operator's skin, resulting in easy and safe operation. In particular, when a rubber sheet is used as a finishing material, the aluminum glass cross tape can reinforce an adhesive force of the rubber sheet, enabling an easy finishing operation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A fiberglass pipe-shaped insulator comprising:
a fiberglass needle mat prepared by needle punching of glass fibers, the fiberglass needle mat being coated at one surface or both surfaces thereof with a binder prepared by mixing and agitating organic and inorganic substances, a fire retardant, and water, the fiberglass needle mat being press-formed by a press roller while being rotated in a state wherein the fiberglass needle mat is wound on a forming roller to form a press-formed fiberglass pipe-shaped insulator, the press-formed fiberglass pipe-shaped insulator being sufficiently dried prior to being separated from the forming roller and being sequentially subjected to center cutting and side cutting after being dried; and
an aluminum glass cross tape attached throughout an outer circumferential surface of the press-formed fiberglass pipe-shaped insulator after performing the center cutting and before the side cutting of the press-formed fiberglass pipe-shaped insulator.

2. The insulator according to claim 1, wherein opposite side regions of the fiberglass needle mat are partially removed by cutting to form cutting faces at unaligned positions, to provide both ends of the fiberglass pipe-shaped insulator with a coupling recess and a coupling protrusion, respectively, during the press-forming of the fiberglass needle mat wound on the forming roller.

3. A method of manufacturing a fiberglass pipe-shaped insulator comprising:
forming a fiberglass needle mat by needle punching of glass fibers having an appropriate thickness;
press-forming the fiberglass needle mat using a press roller while rotating the fiberglass needle mat in a state wherein the fiberglass needle mat is wound on a forming roller, to form a press-formed fiberglass pipe-shaped insulator, the fiberglass needle mat being coated at one surface or both surfaces thereof with a binder prepared by mixing and agitating organic and inorganic substances, a fire retardant, and water;
drying the press-formed fiberglass pipe-shaped insulator in a state wherein the fiberglass pipe-shaped insulator is wound on the forming roller;
performing center cutting on the fiberglass pipe-shaped insulator after separating the dried fiberglass pipe-shaped insulator from the forming roller;
attaching an aluminum glass cross tape throughout an outer circumferential surface of the centrally cut fiberglass pipe-shaped insulator; and
performing side cutting to remove opposite ends of the fiberglass pipe-shaped insulator to which the aluminum glass cross tape is attached.

4. The method according to claim 3, further comprising: between the step of forming the fiberglass needle mat and the step of press-forming the fiberglass needle mat, removing partial opposite side regions of the fiberglass needle mat by cutting to form cutting faces at unaligned positions.

5. The method according to claim 3, wherein the binder includes bentonite as the inorganic substance, CMC as the organic substance, and magnesium hydroxide as the fire retardant.

6. The method according to claim 3, wherein the binder is prepared by mixing and agitating 2 to 6% by volume bentonite powder as the inorganic substance with 94 to 98% by volume water to obtain a primary agitated product, mixing and agitating 2 to 7% by volume magnesium hydroxide as the fire retardant with 93 to 98% by volume of the primary agitated product to obtain a secondary agitated product, and mixing and agitating 7 to 16% by volume CMC as the organic substance with 84 to 93% by volume of the secondary agitated product.

7. The method according to claim 4, wherein 0.2 to 1% by volume of a fluorine-based water repellent is mixed and agitated with 99 to 99.8% by volume of the binder.
